(19) United States
(12) Patent Application Publication
(10) Pub. No.: US 2014/0047838 A1
(43) Pub. Date: Feb. 20, 2014

(54) CONCENTRATED SOLAR ENERGY RECEIVER

(71) Applicants: Mark Marshall Meyers, Mechanicville, NY (US); Sebastian Walter Freund, Unterfoehring (DE)

(72) Inventors: Mark Marshall Meyers, Mechanicville, NY (US); Sebastian Walter Freund, Unterfoehring (DE)

(21) Appl. No.: 13/588,447

(22) Filed: Aug. 17, 2012

(51) Int. Cl. F03G 6/04; F02C 3/04; F24J 2/10; F24J 2/26; F24J 2/48

(52) U.S. Cl. 60/641.14; 126/674; 126/676; 126/684; 60/805

(57) ABSTRACT

Solar energy receivers and methods of using the same are provided. The receiver includes a plurality of absorber members configured to absorb concentrated solar radiation. The plurality of absorber members define at least one fluid transport channel. The solar receiver also includes a plurality of structural plates, wherein each of the plurality of structural plates is positioned between adjacent absorber members to define an inner fluid transport passage and a plurality of outer fluid transport passages. The inner fluid transport passage is in flow communication with the plurality of outer fluid transport passages. The plurality of outer fluid transport passages are in thermal communication with the plurality of absorber members.

### BACKGROUND

The embodiments described herein relate generally to solar energy receivers and, more specifically, to solar energy receivers for heating fluid to a high temperature.

The generation of electric power from thermal energy absorbed from solar radiation has been proposed as a complementary technological approach to the burning of fossil fuels, which may produce benefits, such as reduced emissions and reduced reliance on limited nonrenewable resources.

There are a number of barriers to the increased use of renewable energy in fueling gas turbines. Fueling gas turbines with heat from solar receivers poses difficulties due to the high temperatures required for thermodynamically efficient operation. Many known solar receivers are limited by maximum operational temperatures of much less than 1000° C. before their components reach a melting point and break down.

### BRIEF DESCRIPTION

In one aspect, a solar energy receiver is provided. The receiver includes a plurality of absorber members configured to absorb concentrated solar radiation. The plurality of absorber members define at least one fluid transport channel therein. The solar receiver also includes a plurality of structural plates, wherein each of the plurality of structural plates is positioned between adjacent absorber members to define an inner fluid transport passage and a plurality of outer fluid transport passages. The inner fluid transport passage is in flow communication with the plurality of outer fluid transport passages. The plurality of outer fluid transport passages are in thermal communication with the plurality of absorber members.

In another aspect, a method of heating fluid in a solar receiver is provided. The method includes concentrating solar radiation on the solar receiver, wherein the receiver includes a plurality of absorber members that define at least one fluid transport channel therein. The method also includes channeling fluid through the fluid transport channel for exposing the fluid to thermal energy absorbed by the plurality of absorber members. A pair of structural plates is positioned within the plurality of absorber members to define an inner fluid transport passage and a plurality of outer fluid transport passages. The inner fluid transport passage is in flow communication with the plurality of outer fluid transport passages, and the plurality of outer fluid transport passages are in thermal communication with the plurality of absorber members.

In yet another aspect, a gas turbine engine is provided. The gas turbine engine includes a compressor for compressing fluid, a solar receiver in flow communication with said compressor, and a turbine in flow communication with said solar receiver. The solar receiver includes a plurality of absorber members configured to absorb concentrated solar radiation. The plurality of absorber members define at least one fluid transport channel therein. The solar receiver also includes a plurality of structural plates, wherein each of the plurality of structural plates is positioned between the plurality of absorber members, to define an inner fluid transport passage and a plurality of outer fluid transport passages. The inner fluid transport passage is in flow communication with the plurality of outer fluid transport passages and the plurality of outer fluid transport passages are in thermal communication with the plurality of absorber members.

### DRAWINGS

FIG. 1 illustrates an exemplary power generation system that includes at least one turbine engine in accordance with an embodiment of the present invention.

FIG. 2 is a schematic diagram of an exemplary solar receiver that may be used in a turbine engine in accordance with one embodiment of the present invention.

FIG. 3 is an enlarged schematic diagram showing a detailed portion of the solar receiver shown in FIG. 2.

FIG. 4 is a flowchart illustrating an exemplary method for heating fluid in a solar receiver.

FIG. 5 is a perspective view of an exemplary solar receiver assembly that includes a plurality of solar receivers.

FIG. 6 is a diagram of the exemplary solar receiver assembly shown in FIG. 5 in accordance with the present invention.

FIG. 7 is a diagram of an alternative embodiment of the solar receiver assembly shown in FIG. 5 in accordance with the present invention.

### DETAILED DESCRIPTION

The exemplary solar receiver systems and methods of using the same described herein provide a solar energy receiver that may be used heating a fluid to a high temperature. The description enables one of ordinary skill in the art to make and use the disclosure, and includes descriptions of several exemplary embodiments. However, the disclosure is not limited to heating a fluid in a gas turbine engine, but may be used to heat fluid in any application that includes heating a fluid to a high temperature using solar radiation.

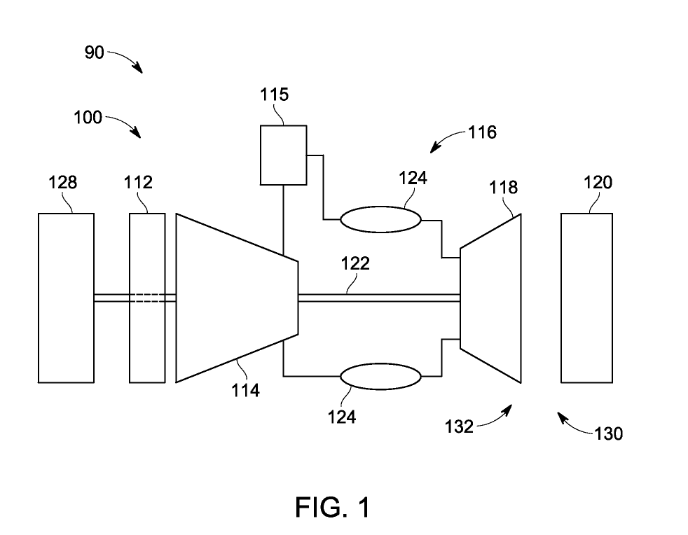

FIG. 1 illustrates an exemplary power generation system 90 that includes at least one turbine engine 100. In the exemplary embodiment, turbine engine 100 is a gas turbine engine. While the exemplary embodiment is directed towards a gas turbine engine for power generation, the present invention is not limited to any one particular engine or application, and one of ordinary skill in the art will appreciate that the current invention may be used in a variety of other applications where a fluid is to be heated to a high temperature using concentrated solar radiation.

In the exemplary embodiment, gas turbine engine 100 includes an intake section 112, a compressor section 114 coupled downstream from intake section 112, a solar receiver element 115 coupled downstream from compressor section 114, a combustor section 116 coupled downstream from solar receiver element 115, a turbine section 118 coupled downstream from combustor section 116, and an exhaust section 120.

Turbine section 118 is coupled in flow communication to compressor section 114 via a rotor shaft 122. In the exemplary embodiment, combustor section 116 includes a plurality of combustors 124. Combustor section 116 is coupled to solar receiver element 115 such that each combustor 124 is positioned in flow communication with solar receiver element 115. Moreover, turbine section 118 is coupled to compressor section 114 and to a load 128 such as, but not limited to, an electrical generator and/or a mechanical drive application. In the exemplary embodiment, each compressor section 114 and turbine section 118 includes at least one rotor disk assembly 130 coupled to a rotor shaft 122 to form a rotor assembly 132.

During operation, intake section 112 channels air towards compressor section 114, wherein the air is compressed to a higher temperature prior to being discharged towards solar receiver element 115. As the compressed air is channeled through solar receiver element 115, it is heated to an even higher pressure and temperature by solar radiation absorbed by solar receiver element 115. Upon exiting solar receiver element 115, the air may be at a sufficient pressure and temperature in some embodiments such that it need not be further heated with the burning of a fossil fuel in combustors 124 to drive turbine section 118. During the daytime, when solar receiver element 115 is operating at typical operation conditions, combustor section 116 may be shut off such that the heated air stream flows through combustors 124 to turbine section 118 without being mixed with fuel. Turbine section 118 converts the thermal energy from the heated air stream to mechanical rotational energy, as the heated air imparts rotational energy to turbine section 118 and to rotor assembly 132. In an alternative embodiment, when solar receiver element 115 is not operating at typical operation conditions, i.e. at night or on cloudy days, fuel may be mixed with air flowing from solar receiver element 115 and ignited to generate combustion gases that are channeled towards turbine section 118. More specifically, in combustors 124, fuel, natural gas for example, is injected into the air flow, and the fuel-air mixture is ignited to generate high temperature combustion gases that are channeled towards turbine section 118.

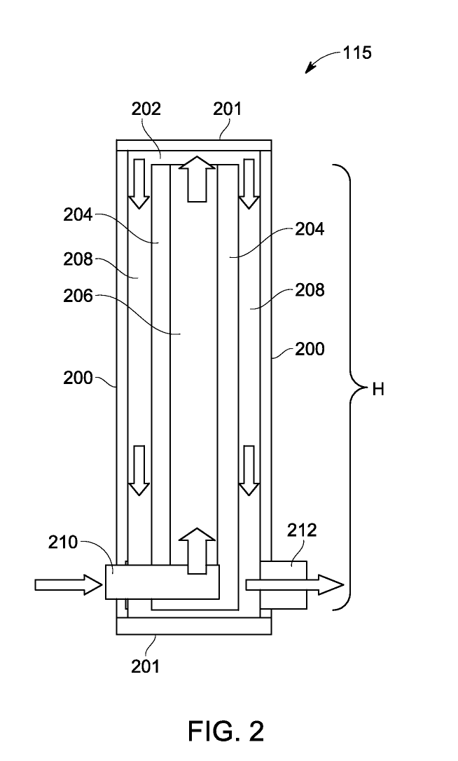

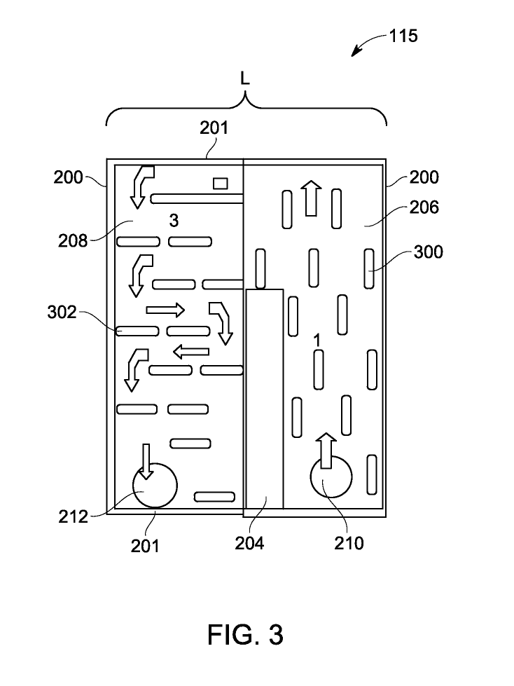

FIG. 2 is a schematic diagram of an exemplary solar receiver element 115 that may be used in turbine engine 100 (both shown in FIG. 1). FIG. 3 is an enlarged schematic diagram showing a detailed portion of solar receiver element 115 shown in FIG. 2. Solar receiver element 115 includes an outer layer defined by a plurality of absorber members 200 that define a fluid transport channel 202 therein, and a plurality of structural plates 204 positioned between absorber members 200 that define an inner fluid transport passage 206 and a plurality of outer fluid transport passages 208.

Absorber members 200 are configured to receive incoming solar radiation to heat fluid flowing within solar receiver element 115. In the exemplary embodiment, absorber members 200 are generally rectangular in shape and are oriented parallel to one another with a space between adjacent absorber members 200. Solar receiver element 115 also includes a plurality of other absorber members 201 oriented perpendicularly with respect to parallel absorber members 200 to close the openings defined between parallel absorber members 200. The positioning of absorber members 200 and 201 adjacent to one another enables solar receiver element 115 to trap incident light that may reflect and/or scatter off the surface of absorber members 200 and 201 by forming a rectangular cavity or fluid transport channel 202 therebetween. Fluid transport channel 202 enables materials with absorptivity less than 0.9 to capture thermal energy without requiring highly absorptive coatings. In the exemplary embodiment, absorber members 200 and 201 are made of a good thermal conducting ceramic material with a high temperature resistance, such as silicon carbide or aluminum nitride. In alternative embodiments, absorber members 200 and 201 may be made of any material that enables solar receiver element 115 to function as described herein. In the exemplary embodiment, absorber members 200 and 201 are made of silicon carbide and have a melting temperature above 2,000° C. and a material working temperature of about 1,500° C. Absorber members 200 and 201 are manufactured in a green state to enable the correct size and shape to be achieved. Once manufactured, absorber members 200 and 201 are coupled together by diffusion bonding to form a monolithic seal, resulting in a solid housing for solar receiver element 115 that contains the pressurized fluid to be heated.

Solar receiver element 115 also includes structural plates 204 positioned between absorber members 200 and 201. The orientation of structural plates 204 defines inner fluid transport passage 206 and outer fluid transport passages 208 within solar receiver element 115. In the exemplary embodiment, structural plates 204 are oriented parallel to one another. A space located between adjacent structural plates 204 defines inner fluid transport passage 206. Structural plates 204 are coupled to one of absorber members 201 and extend parallel to absorber plates 200 over a length L of solar receiver element 115. In the exemplary embodiment, structural plates 204 have a rectangular shape. Structural plates 204 extend a height H, which is less than a height of absorber members 200 to facilitate fluid flow from inner fluid transport passage 206 to outer fluid transport passages 208.

In the exemplary application of a gas turbine described above, inner fluid transport passage 206 is fluidly coupled to compressor 114 (shown in FIG. 1). Solar receiver element 115 includes an inlet distribution channel 210 for receiving fluid from compressor 114 into inner fluid transport passage 206. In the exemplary embodiment, a plurality of support columns 300 are coupled to structural plates 204 and extend across inner fluid transport passage 206 to provide structural support against pressure forces between inner fluid transport passage 206 and outer fluid transport passages 208.

Inner fluid transport passage 206 is in flow communication with outer fluid transport passages 208. Fluid flowing through inner fluid transport passage 206 enters outer fluid transport passages 208 for exposure to absorber members 200 and 201. In the exemplary embodiment, at least one column or baffle 302 is coupled to at least one of structural plates 204 and absorber members 200 and 201. Baffle 302 extends across at least one of outer fluid transport passages 208. Baffle 302 is configured to guide a flow of fluid in a serpentine path to increase velocity of fluid and improve heat transfer with the increased surface area of absorber members 200 and 201. Baffle 302 also provides structural support against pressure forces between structural plates 204 that define inner fluid transport passage 206 and outer fluid transport passages 208. To further enhance heat transfer, the inside walls of absorber members 200 and 201 may include dimples and/or fins (not shown).

During operation, inner fluid transport passage 206 receives air to be heated from compressor 114 through fluid inlet distribution channel 210. The fluid flows through inner fluid transport passage 206 and into outer fluid transport passages 208 for exposure to absorber members 200 and 201. After the fluid flows through outer fluid transport passages 208, it exits solar receiver element 115 through a fluid outlet distribution channel 212 and flows to combustors 124 (shown in FIG. 1) where it may or may not be mixed with fuel before flowing to turbine section 118 (shown in FIG. 1). Solar receiver element 115 operates at a thermal efficiency greater than 80% with an outlet temperature of about 1200° C., which is the same temperature required to drive a turbine engine. The temperature of the surfaces of absorber member 200 is maintained at a temperature below 1200° C. by controlling the amount of fluid flowing into solar receiver element 115. When the temperature of the surfaces of absorber members 200 is too high, more fluid is introduced into receiver section 115, and when the temperature is too low, fluid flow is decreased in receiver section 115.

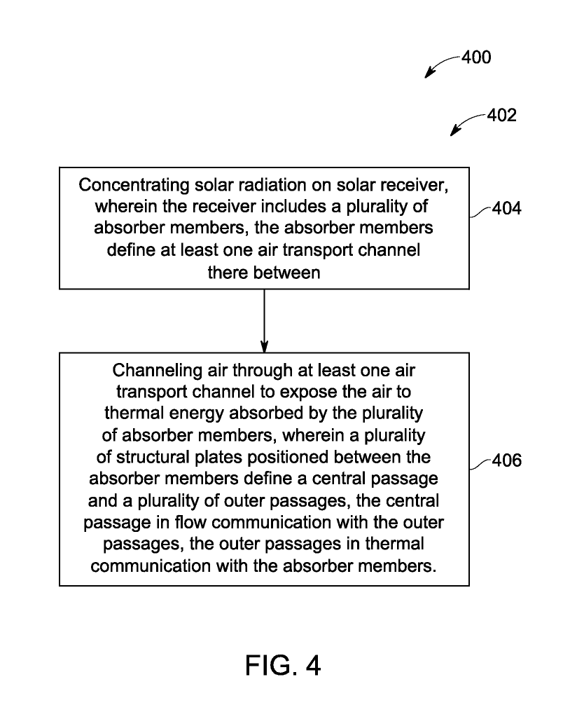

FIG. 4 is a flowchart 400 illustrating an exemplary method 402 for heating fluid in a solar receiver, for example, solar receiver element 115 (shown in FIGS. 2 and 3). Method 402 includes concentrating 404 solar radiation on solar receiver element 115, wherein receiver 115 includes a plurality of absorber members, for example absorber members 200 and 201 (shown in FIGS. 2 and 3), wherein absorber members 200 and 201 define at least one fluid transport channel, for example, fluid transport channel 202 (shown in FIGS. 2 and 3) therebetween. Absorber members 200 and 201 may be made of one of silicon carbide and aluminum nitride. Method 402 also includes channeling 406 fluid through fluid transport channel 202 to expose the fluid to thermal energy absorbed by absorber members 200 and 201, wherein a plurality of structural plates 204 positioned between absorber members 200 define an inner fluid transport passage, for example inner fluid transport passage 206, and a plurality of outer fluid transport passages, for example, outer fluid transport passages 208. Inner fluid transport passage 206 is in flow communication with outer fluid transport passages 208, and outer fluid transport passages 208 are in thermal communication with absorber members 200.

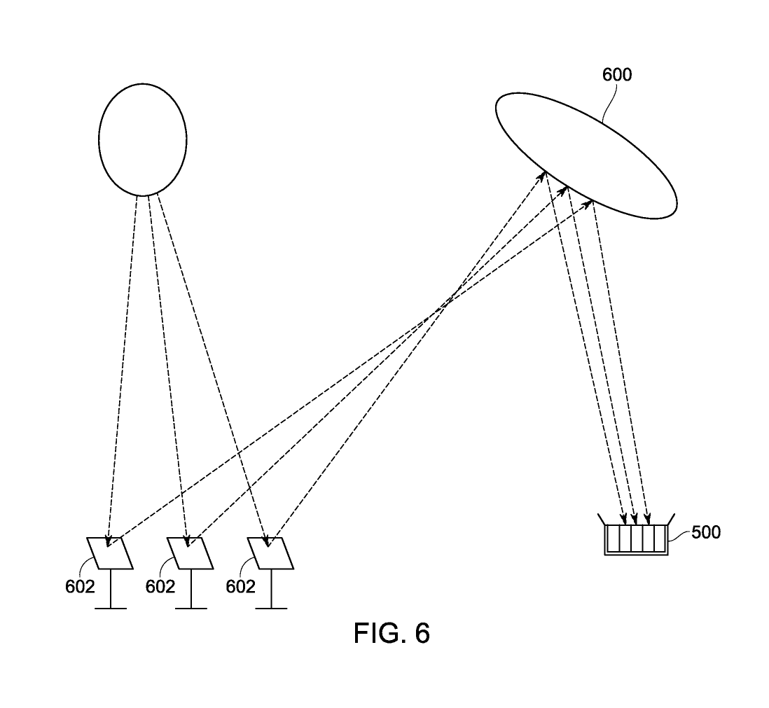

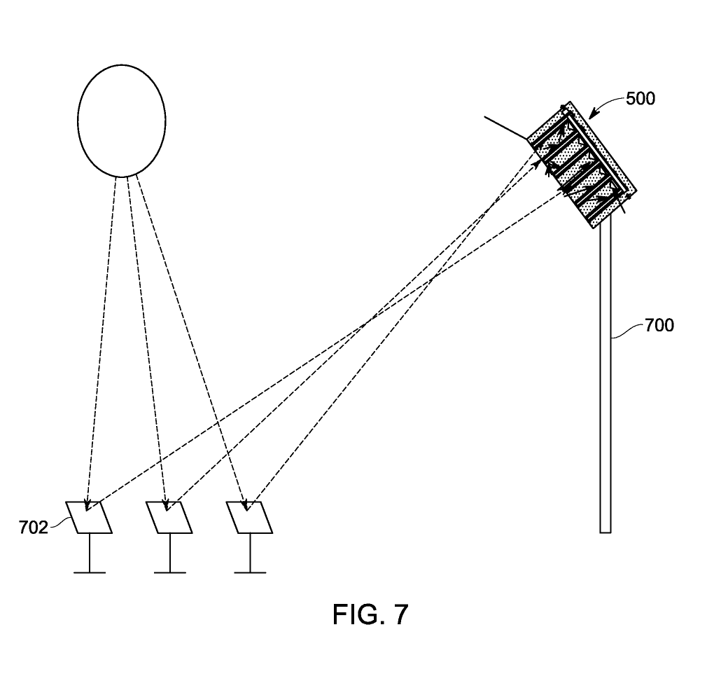

Concentrating 404 solar radiation on solar receiver element 115 may also include configuring a plurality of heliostats (shown in FIGS. 6 and 7) to direct solar radiation towards solar receiver element 115 and absorbing the solar radiation by absorber members 200.

Channeling 406 fluid through the at least one fluid transport channel may also include receiving air channeled from a compressor, for example, compressor 114 (shown in FIG. 1), of a gas turbine engine, for example, gas turbine engine 100 (shown in FIG. 1), engine through a fluid inlet, for example, inlet distribution channel 210 (shown in FIG. 2) of receiver 115, channeling the fluid through inner fluid transport passage 206 into outer fluid transport passages 208, exposing the fluid in outer fluid transport passages 208 to thermal energy absorbed by absorber members 200, and channeling the fluid through a fluid outlet, for example, outlet distribution channel 212 (shown in FIG. 2), of receiver 115 towards a turbine, for example, turbine 118 (shown in FIG. 1), of gas turbine engine 100. Moreover, channeling 406 fluid through fluid transport channel 202 may also include channeling the fluid in a serpentine path using at least one baffle guide, for example, baffle 302 (shown in FIG. 3), coupled to one of structural plates 204 and absorber members 200, wherein baffle 302 extends across at least one of outer fluid transport passages 208.

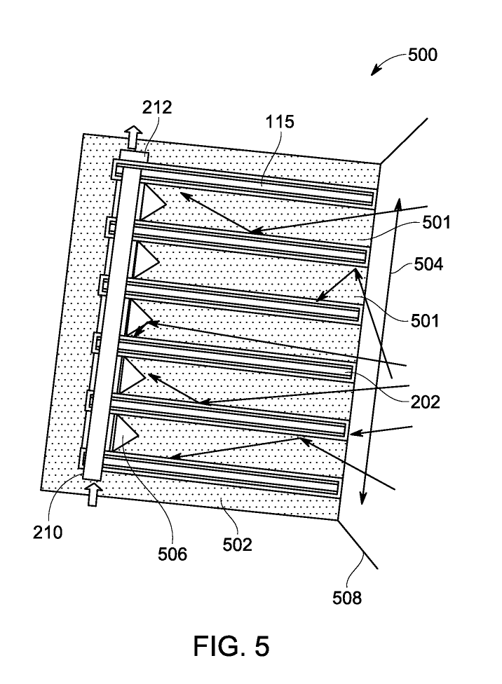

FIG. 5 is a perspective view of an exemplary solar receiver assembly 500 that includes a plurality of solar receiver elements 115 (shown in FIGS. 2 and 3) positioned parallel to one another. In the exemplary embodiment, each solar receiver element 115 includes a plurality of absorber members 200 and 201 (shown in FIGS. 2 and 3) that define at least one fluid transport channel 202 (shown in FIGS. 2 and 3) therebetween. Solar receiver elements 115 are spaced such that they define a plurality of cavities 501 between adjacent solar receiver elements 115. Absorber members 200 and 201 are configured to receive solar radiation entering solar receiver assembly 500 through cavities 501.

In the exemplary embodiment, solar receiver assembly 500 also includes a housing 502 that encompasses the elements of receiver assembly 500 and defines an aperture 504 located on one side of housing 502 that enables incoming radiation to enter receiver assembly 500 between solar receiver elements 115. In one embodiment, housing 502 is fabricated from silicon carbide. In another embodiment, housing 502 is fabricated from aluminum nitride. Solar receiver elements 115 are spaced with enough distance between one another such that a sufficient amount of solar radiation enters housing 502, but close enough to one another to trap incident radiation from escaping housing 502. In one embodiment, solar receiver assembly 500 includes reflectors 506 at the base of housing 502 between each solar receiver element 115 for trapping incident radiation and/or reflectors 508 outside housing 502 for reflecting misaligned solar radiation. In another embodiment, solar receiver assembly 500 includes reflector fins 508 outside housing 502 for reflecting misaligned solar radiation.

During operation, solar radiation is concentrated towards solar receiver assembly 500. Solar receiver assembly 500 is positioned at an angle such that the incoming radiation enters housing 502 through aperture 504 at a small angle relative to solar receiver elements 115 to increase absorption of the radiation by solar receiver elements 115. Reflector fins 508 further reduce losses by redirecting radiation towards solar receiver elements 115 and trapping it within housing 502. Reflector fins 508 redirect solar radiation towards aperture 504 to reduce spillage caused by misaligned radiation. Fluid flows from inlet distribution channel 210 through inner fluid transport passage 206 of each solar receiver element 115. The fluid then flows into outer fluid transport passage 208 where it is subjected to a high amount of radiation absorbed by absorber members 200. The heated fluid flows out of solar receiver assembly through outlet distribution channel 212.

FIG. 6 is a diagram of solar receiver assembly 500 (shown in FIG. 5) in accordance with one embodiment of the present invention. In the exemplary embodiment, solar receiver assembly 500 is positioned on ground level and a reflector tower 600 directs solar radiation into solar receiver assembly 500. Reflector tower 600 receives the solar radiation from multiple heliostats 602 and reflects the radiation towards solar receiver assembly 500. Positioning solar receiver assembly 500 on the ground also enables turbine 100 (shown in FIG. 1) to be positioned on the ground, which reduces maintenance costs. Additionally, having the hot fluid outlet on the ground near turbine 100 reduces the length of piping used to transfer the hot fluid, which minimizes heat losses during the transfer.

FIG. 7 is a diagram of an alternative embodiment of solar receiver assembly 500 (shown in FIG. 5) in accordance with another embodiment of the present invention. In the alternative embodiment shown in FIG. 7, solar receiver assembly 500 is mounted on a receiver tower 700 at a height that enables multiple rows of heliostats 702 to direct solar radiation at solar receiver assembly 500. Heliostats 702 are generally spaced in a plurality of rows with respect to receiver tower 700 and are positioned to concentrate solar radiation towards solar receiver assembly 500. Heliostats 702 are spaced from one another at predetermined distances to avoid blockage by the other heliostats 702. If the distance between heliostats 702 is too short or the height of receiver tower 700 is too low, reflected radiation from certain heliostats 702 may be blocked by other heliostats 702 nearby.

The above-described embodiments facilitate providing solar energy receivers and methods of using the same that can withstand higher operating temperatures than traditional solar receivers, while also being able to drive a gas turbine engine with less or no use of fossil fuels. Specifically, the solar energy receivers described herein use a plurality of absorber members configured to absorb solar radiation. The absorber members may be made of a ceramic material that can withstand high temperatures. The plurality of absorber members define a plurality of fluid channels and open cavities between adjacent absorber members. Concentrated radiation enters the cavities and is absorbed by the absorber members. The radiation heats fluid inside the fluid channels to very high temperatures. For example, the fluid may be air to be heated to a temperature required for driving a gas turbine engine exclusively with solar heat, such as, 1200° C. The temperature of the solar energy receivers described herein can be controlled by regulating the flow of fluid through the receiver, enabling the receiver to operate at an efficient level.

Exemplary embodiments of concentrated solar power receivers are described above in detail. The receivers and methods of using the same are not limited to the specific embodiments described herein, but rather, components of systems and/or steps of the methods may be utilized independently and separately from other components and/or steps described herein. For example, the methods may also be used in combination with other solar energy receiving systems and methods, and are not limited to practice with only the concentrated solar energy receivers and methods of using the same, as is described herein. Rather, the exemplary embodiment can be implemented and utilized in connection with many solar receiver applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A solar energy receiver for use in operating a gas turbine, said receiver comprising:
a plurality of absorber members configured to absorb concentrated solar radiation, said plurality of absorber members defining at least one fluid transport channel therein; and
a plurality of structural plates, each structural plate of said plurality of structural plates positioned between adjacent absorber members of said plurality of absorber members, said plurality of structural plates defining an inner fluid transport passage and a plurality of outer fluid transport passages, said inner fluid transport passage in flow communication with said plurality of outer fluid transport passages, said plurality of outer fluid transport passages in thermal communication with said plurality of absorber members.

2. A solar energy receiver in accordance with claim 1, wherein the fluid comprises compressed air to be expanded in a gas turbine to facilitate power generation.

3. A solar energy receiver in accordance with claim 1, wherein said plurality of absorber members comprise one of silicon carbide and aluminum nitride.

4. A solar energy receiver in accordance with claim 1, further comprising at least one support column coupled to said plurality of structural plates, said plurality of support columns extending across said inner fluid transport passage.

5. A solar energy receiver in accordance with claim 1, further comprising at least one baffle guide coupled to at least one of said plurality of structural plates and to said plurality of absorber members, said at least one baffle guide extending across at least one of said plurality of outer fluid transport passages, said at least one baffle guide configured to guide a flow of fluid in a serpentine path.

6. A solar energy receiver in accordance with claim 1, wherein a temperature of said plurality of absorber members is controlled by regulating a flow of fluid through said fluid transport channel.

7. A solar energy receiver in accordance with claim 1, wherein said plurality of absorber members define a plurality of parallel fluid transport channels and a plurality of cavities between adjacent fluid transport channels.

8. A solar energy receiver in accordance with claim 7, wherein said absorber members are configured to receive solar radiation entering said receiver through said plurality of cavities.

9. A solar energy receiver in accordance with claim 1, wherein said inner fluid transport passage comprises an inlet distribution channel and said first and second outer fluid transport passages comprise an outlet collection channel for discharging heated fluid.

10. A method of heating fluid in a solar receiver, said method comprising:
concentrating solar radiation on the solar receiver, the receiver including a plurality of absorber members defining at least one fluid transport channel therebetween; and
channeling fluid through the at least one fluid transport channel to expose the fluid to thermal energy absorbed by the plurality of absorber members, wherein a plurality of structural plates positioned between adjacent absorber members of the plurality of absorber members define an inner fluid transport passage and a plurality of outer fluid transport passages, the inner fluid transport passage in flow communication with the plurality of outer fluid transport passages, the plurality of outer fluid transport passages in thermal communication with the plurality of absorber members.

11. A method in accordance with claim 10, wherein concentrating solar radiation on a plurality of absorber members further comprises:
configuring a plurality of heliostats to direct solar radiation towards the solar receiver; and
absorbing the directed solar radiation by the plurality of absorber members.

12. A method in accordance with claim 10, wherein channeling fluid through the at least one fluid transport channel further comprises:
receiving fluid channeled from a compressor of a gas turbine engine through a fluid inlet distribution channel of the receiver;
channeling the fluid through the inner fluid transport passage into the plurality of outer fluid transport passages;
exposing the fluid in the plurality of outer fluid transport passages to thermal energy absorbed by the plurality of absorber members; and
channeling the fluid through a fluid outlet collection channel of the receiver towards a turbine of the gas turbine engine.

13. A method in accordance with claim 10, wherein channeling fluid through the at least one fluid transport channel further comprises channeling the fluid in a serpentine path using at least one baffle guide coupled to at least one of the plurality of structural plates and the plurality of absorber members, wherein the baffle guide extends across at least one of the plurality of outer fluid transport passages.

14. A method in accordance with claim 10, wherein channeling fluid through the at least one fluid transport channel further comprises channeling the fluid through a plurality of parallel fluid transport channels defined by the plurality of absorber members, wherein the plurality of absorber members define a plurality of cavities between adjacent fluid transport channels.

15. A gas turbine engine comprising:
a compressor for compressing air;
a solar receiver in flow communication with said compressor, said receiver comprising:
a plurality of absorber members configured to absorb concentrated solar radiation, said plurality of absorber members defining at least one fluid transport channel therein; and
a plurality of structural plates, each structural plate of said plurality of structural plates positioned between adjacent absorber members of said plurality of absorber members, said plurality of structural plates defining an inner fluid transport passage and a plurality of outer fluid transport passages, said inner fluid transport passage in flow communication with said plurality of outer fluid transport passages, said plurality of outer fluid transport passages in thermal communication with said plurality of absorber members; and
a turbine in flow communication with said solar receiver.

16. A gas turbine engine in accordance with claim 15, further comprising a combustor.

17. A gas turbine engine in accordance with claim 15, wherein said turbine is operated solely using air heated by said solar receiver.

18. A gas turbine engine in accordance with claim 15, wherein said plurality of absorber members comprise one of silicon carbide and aluminum nitride.

19. A gas turbine engine in accordance with claim 15, wherein said plurality of absorber members define a plurality of parallel fluid transport channels and a plurality of cavities between adjacent fluid transport channels.

20. A gas turbine engine in accordance with claim 15, wherein said solar receiver is positioned at ground level, and said gas turbine engine is configured to receive solar radiation from a tower reflector.
